(19) United States
(12) Patent Application Publication
(10) Pub. No.: US 2024/0186550 A1
(43) Pub. Date: Jun. 6, 2024

(54) FUEL CELL CONTROL PROGRAM AND FUEL CELL SYSTEM

(71) Applicants: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP)

(72) Inventors: Masao SUZUKI, Nagakute-shi (JP); Naoki KITANO, Nagakute-shi (JP); Masahiro IMANISHI, Gotemba-shi (JP)

(73) Assignees: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP)

(21) Appl. No.: 18/277,151

(22) PCT Filed: Feb. 17, 2022
(86) PCT No.: PCT/JP2022/006503

§ 371 Date: Aug. 14, 2023

(30) Foreign Application Priority Data
Apr. 19, 2021 (JP) 2021-070506

(51) Int. Cl. H01M 8/04992; H01M 8/0444; H01M 8/04746; H01M 8/04828; H01M 8/04858; H01M 8/1018

(52) U.S. Cl. CPC H01M 8/04992; H01M 8/0444; H01M 8/04746; H01M 8/04828; H01M 8/04865; H01M 8/04895; H01M 8/1018

(57) ABSTRACT

Based on an operation condition φ(t) of a polymer electrolyte fuel cell at a time t, the concentration distribution of a radical generation ion and the concentration distribution of a radical scavenging ion in an electrolyte membrane are estimated. Next, a load command p(t+Δt) at a time (t+Δt) is acquired. Next, a reference operation condition φ^{ref}(t+Δt) under which the load command p(t+Δt) can be realized is acquired. Next, whether or not a judgment index exceeds a first threshold value ϵ₁ is judged. When the judgment index exceeds ϵ₁, an operation condition which is different from φ^{ref}(t+≢t) and gives the judgment index of ϵ₁ or less is selected as φ(t+Δt). On the other hand, when the judgment index does not exceed ϵ₁, φ^{ref}(t+Δt) is selected as φ(t+Δt). The fuel cell system has a control device for performing such treatments.

### FIELD OF THE INVENTION

The present invention relates to a fuel cell control program and a fuel cell system and more specifically, relates to a fuel cell control program capable of suppressing the deterioration of an electrolyte due to a radical and a fuel cell system equipped with this program.

### BACKGROUND OF THE INVENTION

A polymer electrolyte fuel cell has a membrane electrode assembly (MEA) in which a catalyst layer is bonded to both sides of an electrolyte membrane. Usually, a gas diffusion layer is disposed outside the catalyst layer. Further, a separator (also called “current collector”) equipped with a gas flow path is disposed outside the gas diffusion layer. The polymer electrolyte fuel cell usually has a structure (fuel cell stack) in which a plurality of unit cells each including such MEA, the gas diffusion layer, and the separator are stacked one after another.

During the operation of a polymer electrolyte fuel cell, hydrogen peroxide is generated in an anode catalyst layer and the Fenton reaction converts this hydrogen peroxide into an ·OH radical. The resulting ·OH radical is known to deteriorate an electrolyte in the MEA. The deterioration in electrolyte becomes a cause for reducing the durability of the fuel cell or for reducing the power generation performance of the fuel cell. In order to overcome this problem, various proposals have therefore been made conventionally.

For example, Patent Literature 1 discloses a fuel cell system, though it is not intended for suppressing the deterioration of an electrolyte due to a radical, when a difference between a pressure of a fuel gas to be introduced into a fuel cell and a pressure of an oxidizing agent gas to be discharged from the fuel cell is a predetermined value or more:

(a) that reduces the pressure of a hydrogen gas when the humidity of a membrane electrode assembly is a first threshold value or more, and

(b) that increases the pressure of air when the humidity of the membrane electrode assembly is less than the first threshold value.

The Literature describes the following points:

(A) when there is a large difference between a pressure in a hydrogen flow path on an anode side and a pressure in an oxygen flow path on a cathode side, this pressure difference may cause deformation of MEA,

(B) a simple reduction in a pressure difference between electrodes in order to suppress the deformation of MEA may cause drying-up or flooding,

(C) a reduction in hydrogen gas pressure at the time when the humidity of MEA is a first threshold value or more reduces the pressure difference between electrodes and at the same time, prevents flooding because a saturated steam quantity of a hydrogen gas increases and the humidity of MEA decreases; and

(D) an increase in air pressure at the time when the humidity of MEA is less than the first threshold value reduces the pressure difference between electrodes and at the same time, prevents drying-up because the saturated steam quantity of air decreases and the humidity of MEA increases.

Using the method described in Patent Literature 1 makes it possible to suppress a mechanical-stress-induced deterioration of an electrolyte membrane. However, the method described in Patent Literature 1 is not able to suppress the radical-induced deterioration of an electrolyte. Further, an example of a fuel cell control method capable of suppressing the radical-induced electrolyte deterioration has not conventionally been proposed.

### CITATION LIST

### Patent Literature

[Patent Literature 1] Japanese Unexamined Patent Application Publication No. 2016-126932

### SUMMARY OF THE INVENTION

A problem to be solved by the present invention is to provide a fuel cell control program capable of suppressing the radical-induced deterioration of an electrolyte membrane by controlling operation condition.

Another problem to be solved by the present invention is to provide a fuel cell system equipped with such a fuel cell control program.

In order to overcome the aforesaid problems, the fuel cell control program according to the present invention has a program for having a computer perform the following procedures.

(A) Procedure A of estimating, based on an operation condition φ(t) at a time t of a polymer electrolyte fuel cell containing, in an electrolyte membrane thereof, a radical generating ion and a radical scavenging ion, a concentration distribution C_{g}(z,t) of the radical generating ion and a concentration distribution C_{g}(z,t) of the radical scavenging ion (z means a membrane-thickness direction position in the electrolyte membrane) in the electrolyte membrane and storing the concentration distributions in a memory,

(B) Procedure B of acquiring a load command p(t+Δt) at a time (t+Δt) and storing the load command in the memory,

(C) Procedure C of acquiring a reference operation condition φ^{ref}(t+Δt) under which the load command φ(t+Δt) can be realized and storing the reference operation condition in the memory,

(D) Procedure D of judging whether or not a judgment index f₁(C_{g}(z,t), Cₛ(z,t)) including the C_{g}(z,t) and/or the Cₛ(z,t) exceeds a first threshold value ϵ₁ (or is ϵ₁ or more), and

(E) Procedure E of selecting, as the φ(t+Δt), an operation condition which is different from the φ^{ref}(t+Δt) and under which the f₁(C_{g}(z,t), Cₛ(z,t)) is not more than the ϵ₁ (or is less than the ϵ₁) when the f₁(C_{g}(z,t), Cₛ(z,t)) is judged to exceed the ϵ₁ (or is judged to be the ϵ₁ or more) in the Procedure D and selecting, as the φ(t+Δt), the φ^{ref}(t+Δt) when the f₁(C_{g}(z,t), Cₛ(z,t)) is judged not to exceed the ϵ₁ (or is judged not to be the ϵ₁ or more) in the Procedure D.

The fuel cell system according to the present invention includes:

a polymer electrolyte fuel cell,

a secondary battery for storing surplus electricity generated by the polymer electrolyte fuel cell, and

a control device for controlling an operation of the polymer electrolyte fuel cell and the secondary battery,

wherein the control device has a fuel cell control program according to the present invention housed therein.

The fuel cell control program according to the present invention:

(a) successively estimates a concentration distribution C_{g}(z,t) of a radical generating ion and a concentration distribution Cₛ(z,t) of a radical scavenging ion in an electrolyte membrane at a time t (Procedure A),

(b) judges whether or not a locally concentrated region of the radical generating ion is formed (in other words, judges whether or not the judgment index f₁(C_{g}(z,t), Cₛ(z,t)) exceeds a first threshold value ϵ₁) when an operation condition is changed (in other words, when a load demand p(t+Δt) at a time (t+Δt) is acquired) and the changed operation condition is performed as is (Procedures B to D), and

(c) selects an operation condition different from a reference operation condition φ^{ref}(t+Δt) which is to be determined based on the load command p(t+Δt) (in other words, selects an operation condition capable of mitigating the local concentration of the radical generating ion), when it is judged that there is a high possibility of a region in which the radical generating ion is locally concentrated being formed (Procedure E).

Even if there is a change in potential gradient, ion concentration gradient, humidity gradient, or the like which may occur in the electrolyte membrane during the operation of the fuel cell, therefore, it is possible to suppress the deterioration of the electrolyte membrane caused by the temporary formation of a region in which the radical generating ion is concentrated.

### BRIEF DESCRIPTION OF THE DRAWINGS

FIG. 1 is a flow chart of the fuel cell control program according to the present invention.

FIG. 2A is a diagram illustrating a time-dependent change of a current density.

FIG. 2B is a diagram illustrating a time-dependent change of a maximum ion concentration ratio in a membrane perpendicular direction.

FIG. 3 is a diagram illustrating the relation between a membrane-thickness-direction relative position and a metal ion concentration relative ratio or ion concentration ratio at Point A of FIG. 2B.

FIG. 4 is a diagram illustrating the relation between a membrane-thickness-direction relative position and a metal ion concentration relative ratio or ion concentration ratio at Point B of FIG. 2B.

FIG. 5 is a diagram illustrating the relation between a membrane-thickness-direction relative position and a metal ion concentration relative ratio or ion concentration ratio at Point C of FIG. 2B.

FIG. 6 is a diagram illustrating the relation between a membrane-thickness-direction relative position and a metal ion concentration relative ratio or ion concentration ratio at Point D of FIG. 2B.

FIG. 7 is a diagram illustrating the relation between a membrane-thickness-direction relative position and a metal ion concentration relative ratio or ion concentration ratio at Point E of FIG. 2B.

FIG. 8 is a diagram illustrating the relation between a membrane-thickness-direction relative position and a metal ion concentration relative ratio or ion concentration ratio at Point F of FIG. 2B.

### DETAILED DESCRIPTION OF PREFERRED EMBODIMENTS

One embodiment of the present invention will hereinafter be described in detail.

### 1. Variable

Table 1 shows a list of variables used herein.

TABLE 1

| | |
|---|---|
| t | time |
| Δt | time increment |
| p | load command |
| C_{g} | concentration distribution of radical |
| | generating ion |
| Cₛ | concentration distribution of radical |
| | scavenging ion |
| ϕ | operation condition |
| I | current |
| V | voltage |
| RH_{ca} | relative humidity of cathode gas |
| RHₐₙ | relative humidity of anode gas |
| P_{ca} | pressure of cathode gas |
| Pₐₙ | pressure of anode gas |
| Q_{ca} | flow rate of cathode gas |
| Qₐₙ | flow rate of anode gas |
| ϕ^{ref} | reference operation condition |
| I^{ref} | reference current |
| V^{ref} | reference voltage |
| RH_{ca}^{ref} | reference relative humidity of cathode gas |
| RHₐₙ^{ref} | reference relative humidity of anode gas |
| P_{ca}^{ref} | reference pressure of cathode gas |
| Pₐₙ^{ref} | reference pressure of anode gas |
| Q_{ca}^{ref} | reference flow rate of cathode gas |
| Qₐₙ^{ref} | reference flow rate of anode gas |

### 2. Fuel Cell Control Program

The fuel cell control program according to the present invention has a program for having a computer perform the following procedures.

### 2.1. Procedure A

First, based on an operation condition φ(t) at a time t of a polymer electrolyte fuel cell containing, in an electrolyte membrane thereof, a radical generating ion and a radical scavenging ion, a concentration distribution C_{g}(z,t) of the radical generating ion and a concentration distribution C_{g}(z,t) of the radical scavenging ion (z represents a membrane-thickness-direction position of the electrolyte membrane and when z=0, the position is an anode-side end portion and when z=L, the position is a cathode-side end portion) are estimated and they are stored in a memory (Procedure A).

A metal ion in the electrolyte membrane is known to move according to a potential gradient, an ion concentration gradient, and a humidity gradient (refer to Reference Literature 1 and 2). When the flux of a potential gradient and humidity gradient balances the flux of an ion concentration gradient, the concentration distribution of the metal ion reaches steady state. When the potential gradient, ion concentration gradient, and humidity gradient in the electrolyte membrane are made clear, therefore, it is possible to estimate C_{g}(z,t) and Cₛ(z,t).

[Reference Literature 1] Kienits, B., et al. (2011). “Cationic Contamination Effects on Polymer Electrolyte Membrane Fuel Cell Performance,” Journal of The Electrochemical Society 158(9) [Reference Literature 2] Shibata, M., et al. (2020). “A Theoretical and Experimental Study on Electrochemical Impedance Spectra of Polymer Electrolyte Membrane Fuel Cells for Cation Content Estimation,” Journal of The Electrochemical Society 167(13)

Examples of the operation condition φ(t) include:

(a) a current I(t), a voltage V(t),

(b) a relative humidity RH_{ca}(t) of a cathode gas, a relative humidity RHₐₙ(t) of an anode gas,

(c) a pressure P_{ca}(t) of the cathode gas, a pressure Pₐₙ(t) of the anode gas,

(d) a flow rate Q_{ca}(t) of the cathode gas, and a flow rate Qₐₙ(t) of the anode gas.

Of these, the current I(t) and the voltage V(t) contribute to the formation of the potential gradient in the electrolyte membrane. On the other hand, the relative humidity RH(t), the pressure P(t), and the flow rate Q(t) each contribute to the formation of the humidity gradient in the electrolyte membrane. When φ(t) is revealed, therefore, C_{g}(z,t) and Cₛ(z,t) can be estimated based on them.

A method of estimating C_{g}(z,t) and Cₛ(z,t) is not particularly limited and the most suitable method can be selected according to the purpose. Specific examples of such a method include the following ones.

### 2.1.1. Metal Ion Transport Equation

A first method is to estimate C_{g}(z,t) and Cₛ(z,t) by using a metal ion transport equation. The procedure A may include a procedure for performing such a method.

More specifically, “the method using a metal ion transport equation” is to couple an equation of a flux represented by the following equation (a) and a mass-charge conservation equation represented by the following equation (b) and thereby estimate a metal ion concentration in a divided volume. The C_{g}(z,t) and Cₛ(z,t) can be found by solving the equations (a) and (b).

$$\begin{matrix}[ Math . 1 ] & \\ ( \begin{matrix}{J}_{H +} \\ {J}_{g} \\ {J}_{s} \\ {J}_{{H}_{2} O}\end{matrix} ) = - ( \begin{matrix}{L}_{11} & {L}_{12} & {L}_{13} & {L}_{14} \\ {L}_{21} & {L}_{22} & {L}_{23} & {L}_{24} \\ {L}_{21} & {L}_{32} & {L}_{33} & {L}_{34} \\ {L}_{21} & {L}_{42} & {L}_{43} & {L}_{44}\end{matrix} ) ( \begin{matrix}∇ {Φ}_{e} \\ ∇ {C}_{g} \\ ∇ {C}_{s} \\ ∇ {C}_{{H}_{2} O}\end{matrix} ) & ( a )\end{matrix}$$

$$( \begin{matrix}0 \\ \frac{{dC}_{g}}{dt} \\ \frac{{dC}_{s}}{dt} \\ \frac{{dC}_{{H}_{2} O}}{dt}\end{matrix} ) = - ( \begin{matrix}∇ ( {J}_{H +} + {Z}_{cg} {J}_{g} + {Z}_{cs} {J}_{s} ) \\ ∇ {J}_{g} \\ ∇ {J}_{s} \\ ∇ {J}_{{H}_{2} O}\end{matrix} ) \qquad ( b )$$

where

J represents a flux,

C represents a metal ion concentration,

Z represents a metal ion valence,

L represents a coefficient,

φₑ represents a potential,

∇φₑ represents a potential gradient,

∇C_{g} and ∇Cₛ represent a concentration gradient of the metal ion, respectively.

∇C_{H2O} represents a concentration gradient of water.

In the equations (a) and (b),

the subscript “H⁺” means that it is a parameter relating to a proton,

the subscript “g” means that it is a parameter relating to a radical generating ion,

the subscript “s” means that it is a parameter relating to a radical scavenging ion, and

the subscript “H₂O” means that it is a parameter relating to water.

### 2.1.2. Simple Solution Method

The second method is to estimate the C_{g}(z,t) and Cₛ(z,t) by a simple solution method. The procedure A may include a procedure for performing such a method.

The term “simple solution method” specifically means a procedure of estimating the C_{g}(z,t) and Cₛ(z,t) by using:

(a) a first map showing the relation between a reference operation condition φ^{ref}(t) at a time t and a concentration C_{g}^{ref}(z,t) of the radical generating ion and a concentration Cₛ^{ref}(z,t) of the radical scavenging ion under a steady state (dC/dt=0) of the φ_{ref}(t), and

(b) a second map showing the relation between the reference operation condition φ^{ref}(t) and a time constant τ of metal ion transport, each map being prepared in advance.

The procedure A may include a procedure for performing such a method.

It is to be noted that a “reference operation condition φ^{ref}” means an operation condition under which a load command requested can be realized and at the same time, the highest power generation efficiency can be attained.

The term “time constant τ” is a time necessary for increasing a cation distribution C(z,t+τ), after retained for the period of a time τ under a certain condition φ(t) with an initial cation distribution as C(z,t), by an amount corresponding to (1-1/e) time (about 63.2%, e is a base of natural logarithm) the difference between C^{ref}(z,t) in the steady state under the aforesaid condition and C(z,t). In short, the “time constant τ” is a value satisfying the following equation:

C(z,t+τ)=C(z,t)+{C^{ref}(z,t)−C(z,t)}(1-1/e)

The concentration C_{g}^{ref}(z,t) of the radical generating ion and the concentration Cₛ^{ref}(z,t) of the radical scavenging ion when a reference operation condition φ^{ref}(t) is set at a time t and it reaches a steady state (dC/dt=0) are found in advance. In addition, the relation between φ^{ref}(t) and C_{g}^{ref}(z,t) or Cₛ^{ref}(z,t) is mapped into a first map and it is stored in a memory.

Similarly, the relation between φ^{ref}(t) and time constant τ is found in advance. In addition, the relation between φ^{ref}(t) and τ is mapped into a second map and it is stored in the memory.

In this case, as the reference operation condition φ^{ref}(t) is determined, C_{g}^{ref}(z,t), Cₛ^{ref}(z,t), and τ are determined. In addition, C_{g}(z,t−Δt) and Cₛ(z,t−Δt) are already known. By substituting them into the equations (c) and (d), the ion distributions C_{g}(z,t) and Cₛ(z,t) at the time t can therefore be estimated.

$$\begin{matrix}[ Math . 2 ] & \\ {C}_{g} ( z , t ) = {C}_{g} ( z , t - Δ t ) + \{ {C}_{g}^{ref} ( z , t ) - {C}_{g} ( z , t - Δ t ) \} \frac{Δ t}{τ} & ( 2 )\end{matrix}$$

$${C}_{s} ( z , t ) = {C}_{s} ( z , t - Δ t ) + \{ {C}_{s}^{ref} ( z , t ) - {C}_{s} ( z , f - Δ f ) \} \frac{Δ T}{τ} \qquad ( d )$$

### 2.2. Procedure B

Next, a load command p(t+Δt) Δt a time (t+Δt) is acquired and it is stored in the memory (Procedure B).

A method of acquiring the load command p(t+Δt) is not particularly limited and the most suitable method can be selected according to the purpose.

### 2.3. Procedure C

Next, a reference operation condition φ^{ref}(t+Δt) under which the load command p(t+Δt) can be realized is acquired and it is stored in the memory (Procedure C).

As described above, the term “reference operation condition φ^{ref}(t+Δt)” means an operation condition under which the load command p(t+Δt) can be realized and at the same time, the highest power generation efficiency can be attained. As the specification of a fuel cell and load command p(t+Δt) are determined, the reference operation condition φ^{ref}(t+Δt) is determined uniquely. A data base showing these relations is stored in the memory in advance and when the load command p(t+Δt) is acquired, the reference operation condition φ^{ref}(t+Δt) is read out from the data base.

### 2.4. Procedure D and Procedure G

### 2.4.1 Procedure D

Next, whether or not a judgment index f₁(C_{g}(z,t), Cₛ(z,t)) including C_{g}(z,t) and/or Cₛ(z,t) exceeds a first threshold value ϵ₁ (or is ϵ₁ or more) is judged (Procedure D).

The term “judgment index f₁(C_{g}(z,t), Cₛ(z,t))” means an index for judging whether or not a region in which the concentration C_{g}(z,t) of the radical generating ion is relatively excessive over the concentration Cₛ(z,t) of the radical scavenging ion appears. The judgment index f₁(C_{g}(z,t), Cₛ(z,t)) is a function of C_{g}(z,t) and/or Cₛ(z,t) because of its nature.

The term “first threshold value ϵ₁” is a threshold value of the judgment index f₁(C_{g}(z,t), Cₛ(z,t)) for judging whether or not the reference operation condition φ^{ref}(t+Δt) acquired in the Procedure C is performed as is.

When the judgment index f₁(C_{g}(z,t), Cₛ(z,t)) does not exceed the first threshold value ϵ₁ (or it is not ϵ₁ or more), there is a low possibility of deterioration of the electrolyte membrane proceeding even if the reference operation condition φ^{ref}(t+Δt) acquired in the Procedure C is performed as is. In this case, the reference operation condition φ^{ref}(t+Δt) is performed as is.

On the other hand, when the judgment index f₁(C_{g}(z,t), Cₛ(z,t)) exceeds the first threshold value ϵ₁ (or it is ϵ₁ or more), there is a high possibility of the deterioration in the electrolyte membrane proceeding. In this case, an operation condition different from the reference operation condition φ^{ref}(t+Δt) is performed.

The judgment index f₁(C_{g}(z,t), Cₛ(z,t)) is not particularly limited in so far as it permits such judgment. One example of the judgment index f₁(C_{g}(z,t), Cₛ(z,t)) is shown in the following equations (1) to (3). In the present invention, any of the following equations (1) to (3) may be used as the judgment index f₁(C_{g}(z,t), Cₛ(z,t)).

$$\begin{matrix}[ Math . 3 ] & \\ {f}_{1} ( {C}_{g} ( z , t ) , {C}_{s} ( z , t ) ) = max \{ \frac{{C}_{g} ( z , t )}{{C}_{s} ( z , t )} \} & ( 1 )\end{matrix}$$

$${f}_{1} ( {C}_{g} ( z , t ) , {C}_{s} ( z , t ) ) = max \{ {C}_{g} ( z , t ) \} \qquad ( 2 )$$

$${f}_{1} ( {C}_{g} ( z , t ) , {C}_{s} ( z , t ) ) = max \{ {C}_{s} ( z , t ) \} \qquad ( 3 )$$

The equations (1) to (3) show that

(a) the maximum C_{g}(z,t)/Cₛ(z,t) ratio in the membrane thickness direction,

(b) the maximum C_{g}(z,t) in the membrane thickness direction, or

(c) the maximum Cₛ(z,t) in the membrane thickness direction are used as the judgment index f₁(C_{g}(z,t), Cₛ(z,t)), respectively. Any of the equations (1) to (3) can be an index for judging the local concentration of the radical generating ion.

### 2.4.2. Procedure G

Assuming that the reference operation condition φ^{ref}(t+Δt) has been selected, how much the deterioration of the electrolyte membrane proceeds should be predicted precisely not by judging with a metal ion concentration (current value) at a current time t but by judging with a metal ion concentration (predicted value) at a time (t+Δt). In other words, it is preferred to use, as the judgment index, not C_{g}(z,t) and/or Cₛ(z,t) but C_{g}(z,t+Δt) and/or Cₛ(z,t+Δt). However, it is the common practice to set, as Δt, a time interval sufficiently shorter than the metal ion transfer rate so that the results are almost similar for both judgment indexes.

When the judgment is made using the metal ion concentration at the time (t+Δt), it is preferred, after the Procedure C and before the Procedure D, to estimate the concentration distribution C_{g}(z,t+Δt) of the radical generating ion and the concentration distribution C_{g}(z,t+Δt) of the radical scavenging ion in the electrolyte membrane at the time (t+Δt) assuming that φ^{ref}(t+Δt) is performed at the time (t+Δt) and store them in the memory (Procedure G). A method of estimating C_{g}(z,t+Δt) and Cₛ(z,t+Δt) is similar to that in the Procedure A so that a description on it will be omitted.

When the Procedure G is performed, the Procedure D preferably includes a procedure of judging whether or not a judgment index f₁(C_{g}(z,t+Δt), Cₛ(z,t+Δt)) instead of the judgment index f₁(C_{g}(z,t), Cₛ(z,t)) exceeds ϵ₁ (or is ϵ₁ or more).

In this case, the judgment index f₁(C_{g}(z,t+Δt), Cₛ(z,t+Δt)) is similar to the judgment index f₁(C_{g}(z,t), Cₛ(z,t)) except for the use of C_{g}(z,t+Δt) and/or Cₛ(z,t+Δt) instead of C_{g}(z,t) and/or Cₛ(z,t) so that a description on it will be omitted.

### 2.5. Procedure E

Next, when f₁(C_{g}(z,t), Cₛ(z,t)) is judged to exceed ϵ₁ (or judged to be ϵ₁ or more) or f₁(C_{g}(z,t+Δt), Cₛ(z,t+Δt)) is judged to exceed ϵ₁ (or judged to be ϵ₁ or more) in the Procedure D, an operation condition which is different from φ^{ref}(t+Δt) and under which the f₁(C_{g}(z,t), Cₛ(z,t)) is ϵ₁ or less is selected as φ(t+Δt) (Procedure E).

On the other hand, when f₁(C_{g}(z,t), Cₛ(z,t)) is judged not to exceed ϵ₁ (or judged not to be ϵ₁ or more) or f₁(C_{g}(z,t+Δt), Cₛ(z,t+Δt)) is judged not to exceed ϵ₁ (or judged not to be ϵ₁ or more) in the Procedure D, φ^{ref}(t+Δt) is selected as φ(t+Δt) (Procedure E).

This means that when it is judged that local concentration of the radical generating ion does not occur even if the reference operation condition φ^{ref}(t+Δt) is performed as is, power is generated under the reference operation condition φ^{ref}(t+Δt).

On the other hand, when it is judged that local concentration of the radical generating ion occurs if the reference operation condition φ^{ref}(t+Δt) is performed as is, power is generated under an operation condition under which local concentration of the radical generating ion is suppressed. In this case, actual electricity of the fuel cell is sometimes excessive or insufficient relative to the load command p. In such a case, it is preferred to store the excessive electricity in a secondary battery or supply the insufficient electricity from the secondary battery.

The following are specific examples of a method of suppressing the local concentration of the radical generating ion. Any one of the following methods may be used, or two or more of them may be used in combination insofar as they can be physically combined.

### 2.5.1. Control of Current I(t): Procedures Elland E₁₂

The Procedure E may include:

(a) Procedure E₁₁ of setting a current I(t+Δt) at the time (t+Δt) to make an absolute value of a current reduction rate smaller than that in the case where φ^{ref}(t+Δt) is assumed to be performed when a transfer rate of the radical scavenging ion is slower than a transfer rate of the radical generating ion, and/or

(b) Procedure E₁₂ of setting the current I(t+Δt) at the time (t+Δt) to make an absolute value of a current increase rate smaller than that in the case where φ^{ref}(t+Δt) is assumed to be performed when a transfer rate of the radical scavenging ion is faster than a transfer rate of the radical generating ion.

First, the case where a transfer rate of the radical scavenging ion is slower than a transfer rate of the radical generating ion is considered.

When a fuel cell is stopped, the radical scavenging ion and the radical generating ion are distributed uniformly in the electrolyte membrane. By starting power generation from this state (by increasing a current I(t)), a potential gradient occurs in the electrolyte membrane to transfer a metal ion to a cathode side. In this case, when the transfer rate of the radical scavenging ion is slower than the transfer rate of the radical generating ion, the radical generating ion reaches the cathode side earlier.

When the fuel cell reaches a steady state, on the other hand, the radical scavenging ion and the radical generating ion are both concentrated on the cathode side. A decrease in current I(t) from this state causes a reduction in potential gradient and a metal ion transfers to the anode side. In this case, when the transfer rate of the radical scavenging ion is slower than the transfer rate of the radical generating ion, the radical generating ion reaches the anode side earlier.

Usually, the concentration of the radical scavenging ion is set higher than the concentration of the radical generating ion. When the transfer rate of the radical scavenging ion is slower than the transfer rate of the radical generating ion and the current increases, there is a high possibility of at least a predetermined amount of the radical scavenging ion being present on the cathode side from the beginning. Even if a current increase rate is relatively fast, therefore, there is a low possibility of the radical generating ion being relatively concentrated on the cathode side.

On the other hand, when the current is decreased from the steady state, there is a high possibility of a reduction in the concentration of the radical scavenging ion on the anode side. When the current reduction rate is relatively fast, therefore, there is a high possibility of the radical generating ion being relatively concentrated on the anode side.

It is therefore preferred to control the current so that the absolute value of the current reduction rate be smaller than that under the reference operation condition when the transfer rate of the radical scavenging ion is slower than the transfer rate of the radical generating ion.

Next, the case where the transfer rate of the radical scavenging ion is faster than the transfer rate of the radical generating ion is considered.

When the transfer rate of the radical scavenging ion is faster than the transfer rate of the radical generating ion and the current increases, there is a high possibility of the radical scavenging ion reaching the cathode side earlier and the radical generating ion being left on the anode side.

It is therefore preferred to control the current so that the absolute value of the current increase rate be smaller than that under the reference operation condition when the transfer rate of the radical scavenging ion is faster than the transfer rate of the radical generating ion.

More specifically, the Procedures E₁₁ and E₁₂ each preferably include a procedure of setting I(t+Δt) by using the following equation (4).

$$\begin{matrix}[ Math . 4 ] & \\ I ( t + Δ t ) = I ( t ) + \frac{1}{{a}_{1}} max ( {a}_{1} ( \frac{{I}^{ref} ( t + Δ t ) - I ( t )}{Δ t} ) , {f}_{I} ( {C}_{s} ( z , t ) , {C}_{g} ( z , t ) ) ) Δ t & ( 4 )\end{matrix}$$

where

f_{I}(Cₛ(z,t), C_{g}(z,t)) is a minimum absolute value of a current change rate determined depending on the concentration of the radical scavenging ion or the concentration of the radical generating ion on a cathode-side surface or anode-side surface of an electrolyte membrane,

I^{ref}(t+Δt) is a reference current included in a reference operation condition φ^{ref}(t+Δt), and

a¹ is a control constant and is a positive real number in the Procedure E₁₁ and a negative real number in the Procedure E₁₂.

The f₁(Cₛ(z,t), C_{g}(z,t)) is not particularly limited and the most suitable value can be selected for it depending on the purpose. Preferred examples of the f_{I}(Cₛ(z,t), C_{g}(z,t)) include those represented by the following equation (4a) or (4b). The f_{I} represented in the equations (4a) and (4b) is a function that always returns a positive value. The f_{I} represents a function that returns a small value when the concentration Cₛ(L,t) of the radical scavenging ion at the end portion (z=L) on the cathode side is larger than an average concentration Cₛ^{ave} of the radical scavenging ion.

$$\begin{matrix}[ Math . 5 ] & \\ {f}_{I} ( {C}_{s} ( z , t ) , {C}_{g} ( z , t ) ) = \frac{{b}_{1}}{{( {C}_{s} ( L , t ) / {C}_{s}^{aνe} )}^{c 1}} & ( 4 a )\end{matrix}$$

$${f}_{I} ( {C}_{s} ( z , t ) , {C}_{g} ( z , t ) ) = \frac{{b}_{1}}{{c 1}_{} ( {C}_{s} ( L , t ) / {C}_{s}^{aνe} )} \qquad ( 4 b )$$

where

b₁ is a control constant and is a positive value,

c₁ is a control constant and c₁>0 in the equation (4a) and c₁>1 in the equation (4b),

L is a thickness of the electrolyte membrane, and

Cₛ^{ave} is an average concentration of the radical scavenging ion.

### 2.5.2. Control of Voltage V(t): Procedures E₂₁ and E₂₂

The Procedure E may include:

(c) Procedure E₂₁ of setting a voltage V(t+Δt) at the time (t+Δt) to make an absolute value of a voltage reduction rate smaller than that in the case where φ^{ref}(t+Δt) is assumed to be performed when a transfer rate of the radical scavenging ion is slower than a transfer rate of the radical generating ion, and/or

(d) Procedure E₂₂ of setting the voltage V(t+Δt) at the time (t+Δt) to make an absolute value of a voltage increase rate smaller than that in the case where φ^{ref}(t+Δt) is assumed to be performed when a transfer rate of the radical scavenging ion is faster than a transfer rate of the radical generating ion.

Voltage V(t), similar to Current I(t), has an influence on the potential gradient in the electrolyte membrane.

It is therefore preferred to control the voltage so that the absolute value of the voltage reduction rate be smaller than that under the reference operation condition when the transfer rate of the radical scavenging ion is slower than the transfer rate of the radical generating ion.

On the contrary, it is preferred to control the voltage so that the absolute value of the voltage increase rate be smaller than that under the reference operation condition when the transfer rate of the radical scavenging ion is faster than the transfer rate of the radical generating ion.

More specifically, the Procedures E₂₁ and E₂₂ each preferably include a procedure of setting V(t+Δt) by using the following equation (5).

$$\begin{matrix}[ Math . 6 ] & \\ V ( t + Δ t ) = V ( t ) + \frac{1}{{2}_{1}} max ( {a}_{2} ( \frac{{V}^{ref} ( t + Δ t ) - V ( t )}{Δ t} ) , {f}_{V} ( {C}_{s} ( z , t ) , {C}_{g} ( z , t ) ) ) Δ t & ( 5 )\end{matrix}$$

where

fᵥ(Cₛ(z,t), C_{g}(z,t)) is a minimum absolute value of a voltage change rate determined depending on the concentration of the radical scavenging ion or the concentration of the radical generating ion on a cathode-side surface or anode-side surface of the electrolyte membrane,

V^{ref}(t+Δt) is a reference voltage included in a reference operation condition φ^{ref}(t+Δt), and

a₂ is a control constant and is a negative real number in the Procedure E₂₁ and a positive real number in the Procedure E₂₂.

The f_{V}(Cₛ(z,t), C_{g}(z,t)) is not particularly limited and the most suitable value can be selected for it depending on the purpose. Preferred examples of the f_{V}(Cs(z,t), C_{g}(z,t)) include those represented by the following equation (5a) or (5b). The f_{V} represented in the equations (5a) and (5b) is a function that always returns a positive value. The f_{V} represents a function that returns a small value when the concentration Cₛ(L,t) of the radical scavenging ion at the end portion on the cathode side is larger than an average concentration Cₛ^{ave} of the radical scavenging ion.

$$\begin{matrix}[ Math . 7 ] & \\ {f}_{V} ( {C}_{s} ( z , t ) , {C}_{g} ( z , t ) ) = \frac{{b}_{2}}{{( {C}_{s} ( L , t ) / {C}_{s}^{aνe} )}^{c2}} & ( 5 a )\end{matrix}$$

$${f}_{V} ( {C}_{s} ( z , t ) , {C}_{g} ( z , t ) ) = \frac{{b}_{1}}{{c 2}_{} ( {C}_{s} ( L , t ) / {C}_{s}^{aνe} )} \qquad ( 5 b )$$

where

b₂ is a control constant and is a real number from 0 to 1,

c₂ is a control constant and is a real number from 0 to 1 in the equation (5a) and c₂>1 in the equation (5b),

L is a thickness of the electrolyte membrane, and

Cₛ^{ave} is an average concentration of the radical scavenging ion.

### 2.5.3. Control of Relative Humidity RH_{ca}(t) of cathode gas: Procedures E₃₁ and E₃₂

The Procedure E may include:

(a) Procedure E₃₁ of setting a relative humidity RH_{ca}(t+Δt) of a cathode gas at the time (t+Δt) to be higher than that under φ^{ref}(t+Δt) when a concentration of the radical scavenging ion or the radical generating ion on a cathode side is higher than that on an anode side, and/or

(b) Procedure E₃₂ of setting the relative humidity RH_{ca}(t+Δt) of the cathode gas at the time (t+Δt) to be lower than that under φ^{ref}(t+Δt) when the concentration of the radical scavenging ion or the radical generating ion on the anode side is higher than that on the cathode side.

First, the case where the concentration of the radical scavenging ion or radical generating ion on the cathode side is higher than that on the anode side is considered. The case where the humidity on the cathode side is larger than that on the anode side is defined as “positive humidity gradient”.

As described above, when the potential gradient in the electrolyte membrane changes, the radical scavenging ion or radical generating ion is sometimes concentrated on the cathode side. In such a case, increasing the relative humidity RH_{ca}(t) of a cathode gas leads to an increase in the positive humidity gradient. As a result, diffusion of a metal ion from the cathode side to the anode side is accelerated.

When the metal ion is concentrated on the cathode side, therefore, the humidity is preferably controlled to make the relative humidity of the cathode gas higher than that of the reference operation condition.

Next, the case where the concentration of the radical scavenging ion or radical generating ion on the anode side is higher than that on the cathode side is considered.

As described above, when the potential gradient in the electrolyte membrane changes, the radical scavenging ion or radical generating ion is sometimes concentrated on the anode side. In such a case, reducing the relative humidity RH_{ca}(t) of a cathode gas leads to a decrease in the positive humidity gradient. As a result, diffusion of a metal ion from the anode side to the cathode side is accelerated.

When the metal ion is concentrated on the anode side, therefore, the humidity is preferably controlled to make the relative humidity of the cathode gas lower than that of the reference operation condition.

More specifically, the Procedures E₃₁ and E₃₂ each preferably include a procedure of setting RH_{ca}(t+Δt) by using the following equation (6).

[Math. 8]

RH_{ca}(t+Δt)=RH_{ca}^{ref}(t+Δt)+f_{RH}^{ca}(Cₛ(z,t), C_{g}(z,t)) (6)

where
f_{RH}^{ca}(Cₛ(z,t), C_{g}(z,t)) is a change margin of a cathode-side humidity determined depending on the concentration of the radical scavenging ion or the concentration of the radical generating ion on a cathode-side surface or anode-side surface of the electrolyte membrane, and

RH_{ca}^{ref}(t+Δt) is a reference relative humidity of the cathode gas included in the reference operation condition φ^{ref}(t+Δt).

The f_{RH}^{ca}(Cₛ(z,t), C_{g}(z,t)) is not particularly limited and the most suitable value can be selected for it depending on the purpose. The f_{RH}^{ca}(Cₛ(z,t), C_{g}(z,t)) is preferably represented, for example, by the following equation (6a). The f_{RH}^{ca} represented by the equation (6a) is 0 when Cₛ (L,t)/Cₛ^{ave} is a value between (1-b₃) and (1+c₃) and when it is a value outside this range, it represents a function that monotonically increases depending on the value of Cₛ(L,t)/Cₛ^{ave}.

$$\begin{matrix}[ Math . 9 ] & \\ {f}_{RH}^{ca} ( {C}_{s} ( z , t ) , {C}_{g} ( z , t ) ) = {a}_{3} \times {min ( \frac{{C}_{s} ( L , t )}{{C}_{s}^{ave}} - 1 + {b}_{3} , max ( \frac{{C}_{s} ( L , t )}{{C}_{s}^{ave}} - 1 - {c}_{3} , 0 ) )}^{d 3} & ( 6 a )\end{matrix}$$

where

a₃ is a control constant and is a positive real number,

b₃ and c₃ are each a control constant and is a real number from 0 to 1,

d₃ is a control constant and is an odd number,

Cₛ(L,t) is a concentration of the radical scavenging ion on the cathode side,

C_{g}(L,t) is a concentration of the radical generating ion on the cathode side, and

Cₐ^{ave} is an average concentration of the radical scavenging ion.

### 2.5.4. Control of Relative Humidity RHₐₙ(t) of anode gas: Procedure E₄₁ and E₄₂

The Procedure E may include:

(c) Procedure E₄₁ of setting a relative humidity RHₐₙ(t+Δt) of an anode gas at a time(t+Δt) to be lower than that under φ^{ref}(t+Δt) when the concentration of the radical scavenging ion or radical generating ion on the cathode side is higher than that on the anode side, and/or

(d) Procedure E₄₂ of setting the relative humidity RHₐₙ(t+Δt) of the anode gas at a time (t+Δt) to be higher than that under φ^{ref}(t+Δt) when the concentration of the radical scavenging ion or radical generating ion on the anode side is higher than that on the cathode side.

Similar to the relative humidity RH_{ca}(t) of the cathode gas, the relative humidity RHₐₙ(t) of the anode gas has an influence on the humidity gradient in the electrolyte membrane.

When a metal ion is concentrated on the cathode side, therefore, the humidity is preferably controlled to make the relative humidity of the anode gas lower than that under the reference operation condition.

On the contrary, when a metal ion is concentrated on the anode side, the humidity is preferably controlled to make the relative humidity of the anode gas higher than that under the reference operation condition.

More specifically, the Procedures E₄₁ and E₄₂ each preferably include a procedure of setting RHₐₙ(t+Δt) by using the following equation (7).

[Math. 10]

RHₐₙ(t+Δt)=RHₐₙ^{ref}(t+Δt)+f_{RH}^{an}(Cₛ(z,t), C_{g}(z,t)) (7)

where

f_{RH}^{an}(Cₛ(z,t), C_{g}(z,t)) is a change margin of an anode-side humidity determined depending on the concentration of the radical scavenging ion or the concentration of the radical generating ion on a cathode-side surface or anode-side surface of the electrolyte membrane, and

RHₐₙ^{ref}(t+Δt) is a reference relative humidity of the anode gas included in the reference operation condition φ_{ref}(t+Δt).

The f_{RH}^{an}(Cₛ(z,t), C_{g}(z,t)) is not particularly limited and the most suitable value can be selected for it depending on the purpose. The f_{RH}^{an}(Cs(z,t), C_{g}(z,t)) is preferably represented, for example, by the following equation (7a). The f_{RH}^{an} represented by the equation (7a) is 0 when Cₛ(L,t)/Cₛ^{ave} is a value between (1-b₄) and (1+c₄) and when it is a value outside this range, it represents a function that monotonically decreases depending on the value of Cₛ(L,t) /Cₛ^{ave}.

$$\begin{matrix}[ Math . 11 ] & \\ {f}_{RH}^{an} ( {C}_{s} ( z , t ) , {C}_{g} ( z , t ) ) = {a}_{4} \times {min ( \frac{{C}_{s} ( L , t )}{{C}_{s}^{ave}} - 1 + {b}_{4} , max ( \frac{{C}_{s} ( L , t )}{{C}_{s}^{ave}} - 1 - {c}_{4} , 0 ) )}^{d 4} & ( 7 a )\end{matrix}$$

where

a₄ is a control constant and is a negative real number,

b₄ and c₄ are each a control constant and is a real number from 0 to 1,

d₄ is a control constant and is an odd number,

Cₛ(L,t) is a concentration of the radical scavenging ion on the cathode side,

C_{g}(L,t) is a concentration of the radical generating ion on the cathode side, and

Cₛ^{ave} is an average concentration of the radical scavenging ion.

### 2.5.5. Control of Pressure P_{ca}(t) of Cathode Gas: Procedures E₅₁ and E₅₂

The Procedure E may include:

(a) Procedure E₅₁ of setting a pressure P_{ca}(t+Δt) of a cathode gas at the time (t+Δt) to be higher than that under the φ^{ref}(t+Δt) when a concentration of the radical scavenging ion or the radical generating ion on a cathode side is higher than that on an anode side, and/or

(b) Procedure E₅₂ of setting the pressure P_{ca}(t+Δt) of the cathode gas at the time (t+Δt) to be lower than that under the φ^{ref}(t+Δt) when a concentration of the radical scavenging ion or the radical generating ion on the anode side is higher than that on the cathode side.

Similar to the relative humidity RH_{ca}(t) of the cathode gas, the pressure P_{ca}(t) of the cathode gas has an influence on the humidity gradient in the electrolyte membrane. In general, with an increase in P_{ca}(t), water becomes unlikely to volatilize from the cathode-side surface of the electrolyte membrane, leading to an increase in the positive humidity gradient.

When a metal ion is concentrated on the cathode side, therefore, a pressure is preferably controlled to make the pressure of the cathode gas higher than that under the reference operation condition.

On the contrary, when a metal ion is concentrated on the anode side, a pressure is preferably controlled to make the pressure of the cathode gas lower than that under the reference operation condition.

More specifically, the Procedures E₅₁ and E.52 each preferably include a procedure of setting P_{ca}(t+Δt) by using the following equation (8).

[Math. 12]

P_{ca}(t+Δt)=P_{ca}^{ref}(t+Δt)+fₚ^{ca}(Cₛ(z,t), C_{g}(z,t)) (8)

where

fₚ^{ca}(Cₛ(z,t), C_{g}(z,t)) is a change margin of the pressure of the cathode gas determined depending on the concentration of the radical scavenging ion or the concentration of the radical generating ion on a cathode-side surface or anode-side surface of the electrolyte membrane, and

P_{ca}^{ref}(t+Δt) is a reference pressure of the cathode gas included in the reference operation condition φ^{ref}(t+Δt).

The fₚ^{ca}(Cₛ(z,t), C_{g}(z,t)) is not particularly limited and the most suitable value can be selected for it depending on the purpose. The fₚ^{ca}(Cₛ(z,t), C_{g}(z,t)) is preferably represented, for example, by the following equation (8a). The fₚ^{ca} represented by the equation (8a) is 0 when Cₛ(L,t)/Cₛ^{ave} is a value between (1-b₅) and (1+c₅) and when it is a value outside this range, it represents a function that monotonically increases depending on the value of Cₛ(L,t)/Cₛ^{ave}.

$$\begin{matrix}[ Math . 13 ] & \\ {f}_{P}^{an} ( {C}_{s} ( z , t ) , {C}_{g} ( z , t ) ) = {a}_{5} \times {min ( \frac{{C}_{s} ( L , t )}{{C}_{s}^{ave}} - 1 + {b}_{5} , max ( \frac{{C}_{s} ( L , t )}{{C}_{s}^{ave}} - 1 - {c}_{5} , 0 ) )}^{d 5} & ( 8 a )\end{matrix}$$

where

a₅ is a control constant and is a positive real number,

b₅ and c₅ are each a control constant and is a real number from 0 to 1,

d₅ is a control constant and is an odd number,

Cₛ(L,t) is a concentration of the radical scavenging ion on the cathode side,

C_{g}(L,t) is a concentration of the radical generating ion on the cathode side, and

Cₛ^{ave} is an average concentration of the radical scavenging ion.

### 2.5.6. Control of Pressure Pₐₙ(t) of anode gas: Procedures E₆₁ and E₆₂

The Procedure E may include:

(c) Procedure E₆₁ of setting a pressure Pₐₙ(t+Δt) of an anode gas at the time (t+Δt) to be lower than that under the φ^{ref}(t+Δt) when a concentration of the radical scavenging ion or the radical generating ion on a cathode side is higher than that on an anode side, and/or

(d) Procedure E₆₂ of setting the pressure Pₐₙ(t+Δt) of the anode gas at the time (t+Δt) to be higher than that under the φ_{ref}(t+Δt) when a concentration of the radical scavenging ion or the radical generating ion on the anode side is higher than that on the cathode side.

Similar to the pressure P_{ca}(t) of the cathode gas, the pressure Pₐₙ(t) of the anode gas has an influence on the humidity gradient in the electrolyte membrane. In general, with an increase in Pₐₙ(t) water becomes unlikely to volatilize from the anode-side surface of the electrolyte membrane, leading to a decrease in the positive humidity gradient.

When a metal ion is concentrated on the cathode side, therefore, a pressure is preferably controlled to make the pressure of the anode gas lower than that under the reference operation condition.

On the contrary, when a metal ion is concentrated on the anode side, a pressure is preferably controlled to make the pressure of the anode gas higher than that under the reference operation condition.

More specifically, the Procedures E₆₁ and E₆₂ each preferably include a procedure of setting Pₐₙ(t+Δt) by using the following equation (9).

[Math. 14]

Pₐₙ(t+Δt)=Pₐₙ^{ref}(t+t)+fₚ^{an}(Cₛ(z,t), C_{g}(z,t)) (9)

where

fₚ^{an}(Cₛ(z,t), C_{g}(z,t)) is a change margin of the pressure of the anode gas determined depending on the concentration of the radical scavenging ion or the concentration of the radical generating ion on a cathode-side surface or anode-side surface of the electrolyte membrane, and

the Pₐₙ^{ref}(t+Δt) is a reference pressure of the anode gas included in the reference operation condition φ^{ref}(t+Δt).

The fₚ^{an}(Cₛ(z,t), C_{g}(z,t)) is not particularly limited and the most suitable value can be selected for it depending on the purpose. The fₚ^{an}(Cₛ(z,t), C_{g}(z,t)) is preferably represented, for example, by the following equation (9a). The fₚ^{an} represented by the equation (9a) is 0 when Cₛ(L,t)/Cₛ^{ave} is a value between (1-b₆) and (1+c₆) and when it is a value outside this range, it represents a function that monotonically decreases depending on the value of Cₛ(L,t)/Cₛ^{ave}.

$$\begin{matrix}[ Math . 15 ] & \\ {f}_{P}^{an} ( {C}_{s} ( z , t ) , {C}_{g} ( z , t ) ) = {a}_{6} \times {min ( \frac{{C}_{s} ( L , t )}{{C}_{s}^{ave}} - 1 + {b}_{6} , max ( \frac{{C}_{s} ( L , t )}{{C}_{s}^{ave}} - 1 - {c}_{1} , 0 ) )}^{d 6} & ( 9 a )\end{matrix}$$

where

a₆ is a control constant and is a negative real number,

b₆ and c₆ are each a control constant and is a real number from 0 to 1,

d₆ is a control constant and is an odd number,

Cₛ(L,t) is a concentration of the radical scavenging ion on the cathode side,

C_{g}(L,t) is a concentration of the radical generating ion on the cathode side, and

Cₛ^{ave} is an average concentration of the radical scavenging ion.

### 2.5.7. Control of Flow Rate Q_{ca}(t) of Cathode Gas: Procedures E₇₁ and E₇₂

The Procedure E may include:

(a) Procedure E₇₁ of setting a flow rate Q_{ca}(t+Δt) of a cathode gas at the time (t+Δt) to be smaller than that under the φ_{ref}(t+Δt) when a concentration of the radical scavenging ion or the radical generating ion on a cathode side is higher than that on an anode side, and/or

(b) Procedure E₇₂ of setting the flow rate Q_{ca}(t+Δt) of the cathode gas at the time (t+Δt) to be larger than that under the φ^{ref}(t+Δt) when a concentration of the radical scavenging ion or the radical generating ion on the anode side is higher than that on the cathode side.

Similar to the relative humidity RH_{ca}(t) of the cathode gas, the flow rate Q_{ca}(t) of the cathode gas has an influence on the humidity gradient in the electrolyte membrane. In general, with a decrease in Q_{ca}(t), water becomes unlikely to volatilize from the cathode-side surface of the electrolyte membrane, leading to an increase in the positive humidity gradient.

When a metal ion is concentrated on the cathode side, therefore, a flow rate is preferably controlled to make the flow rate of the cathode gas smaller than that under the reference operation condition.

On the contrary, when a metal ion is concentrated on the anode side, a flow rate is preferably controlled to make the flow rate of the cathode gas larger than that under the reference operation condition.

More specifically, the Procedures E₇₁ and E₇₂ each preferably include a procedure of setting Q_{ca}(t+Δt) by using the following equation (10).

[Math. 16]

Q_{ca}(t+Δt)=Q_{ca}^{ref}(t+Δt)+f_{Q}^{ca}(Cₛ(z,t), C_{g}(z,t)) (10)

where

f_{Q}^{ca}(Cₛ(z,t), C_{g}(z,t)) is a change margin of the flow rate of the cathode gas determined depending on the concentration of the radical scavenging ion or the concentration of the radical generating ion on a cathode-side surface or anode-side surface of the electrolyte membrane, and

Q_{ca}^{ref}(t+Δt) is a reference flow rate of the cathode gas included in the reference operation condition φ(t+Δt).

The f_{Q}^{ca}(Cₛ(z,t), C_{g}(z,t)) is not particularly limited and the most suitable value can be selected for it depending on the purpose. The f_{Q}^{ca}(Cs(z,t), C_{g}(z,t)) is preferably represented, for example, by the following equation (10a). The f_{Q}^{ca} represented by the equation (10a) is 0 when Cₛ(L,t)/Cₛ^{ave} is a value between (1-b₇) and (1+c₇) and when it is a value outside this range, it represents a function that monotonically decreases depending on the value of Cₛ(L,t)/Cₛ^{ave}.

$$\begin{matrix}[ Math . 17 ] & \\ {f}_{Q}^{an} ( {C}_{s} ( z , t ) , {C}_{g} ( z , t ) ) = {a}_{7} \times {min ( \frac{{C}_{s} ( L , t )}{{C}_{s}^{ave}} - 1 + {b}_{7} , max ( \frac{{C}_{s} ( L , t )}{{C}_{s}^{ave}} - 1 - {c}_{7} , 0 ) )}^{d 7} & ( 10 a )\end{matrix}$$

where

a₇ is a control constant and is a negative real number,

b₇ and c₇ are each a control constant,

d₇ is a control constant and is an odd number,

Cₛ(L,t) is a concentration of the radical scavenging ion on the cathode side,

C_{g}(L,t) is a concentration of the radical generating ion on the cathode side, and

Cₛ^{ave} is an average concentration of the radical scavenging ion.

### 2.5.8. Control of Flow Rate Qₐₙ(t+Δt) of anode gas: Procedure E₈₁ and E₈₂

The Procedure E may include:

(c) Procedure E₈₁ of setting a flow rate Qₐₙ(t+Δt) of an anode gas at the time (t+Δt) to be larger than that under the φ^{ref}(t+Δt) when a concentration of the radical scavenging ion or the radical generating ion on a cathode side is higher than that on an anode side, and/or

(d) Procedure E₈₂ of setting the flow rate Qₐₙ(t+Δt) of the anode gas at the time (t+Δt) to be smaller than that under the φ^{ref}(t+Δt) when a concentration of the radical scavenging ion or the radical generating ion on the anode side is higher than that on the cathode side.

Similar to the flow rate Q_{ca}(t) of the cathode gas, the flow rate Qₐₙ(t) of the anode gas has an influence on the humidity gradient in the electrolyte membrane. In general, with an increase in Qₐₙ(t), water is more likely to volatilize from the anode-side surface of the electrolyte membrane, leading to an increase in the positive humidity gradient.

When a metal ion is concentrated on the cathode side, therefore, a flow rate is preferably controlled to make the flow rate of the anode gas larger than that under the reference operation condition.

On the contrary, when a metal ion is concentrated on the anode side, a flow rate is preferably controlled to make the flow rate of the anode gas smaller than that under the reference operation condition.

More specifically, the Procedures E₈₁ and E₈₂ each preferably include a procedure of setting Qₐₙ(t+Δt) by using the following equation (11).

[Math. 18]

Qₐₙ(t+Δt)=Qₐₙ^{ref}(t+Δt)+f_{Q}^{an}(Cₛ(z,t), C_{g}(z,t)) (11)

where

f_{Q}^{an}(Cₛ(z,t), C_{g}(z,t)) is a change margin of the flow rate of the anode gas determined depending on the concentration of the radical scavenging ion or the concentration of the radical generating ion on a cathode-side surface or anode-side surface of the electrolyte membrane, and

Qₐₙ^{ref}(t+Δt) is a reference flow rate of the anode gas included in the reference operation condition φ^{ref}(t+Δt).

The f_{Q}^{an}(Cₛ(z,t), C_{g}(z,t)) is not particularly limited and the most suitable value can be selected for it depending on the purpose.

The f_{Q}^{an}(Cₛ(z,t), C_{g}(z,t)) is preferably represented, for example, by the following equation (11a). The f_{Q}^{an} represented by the equation (11a) is 0 when Cₛ(L,t)/Cₛ^{ave} is a value between (1-b₈) and (1+c₈) and when it is a value outside this range, it represents a function that monotonically increases depending on the value of Cₛ(L,t)/Cₛ^{ave}.

$$\begin{matrix}[ Math . 19 ] & \\ {f}_{Q}^{an} ( {C}_{s} ( z , t ) , {C}_{g} ( z , t ) ) = {a}_{8} \times {min ( \frac{{C}_{s} ( L , t )}{{C}_{s}^{ave}} - 1 + {b}_{8} , max ( \frac{{C}_{s} ( L , t )}{{C}_{s}^{ave}} - 1 - {c}_{8} , 0 ) )}^{d 8} & ( 11 a )\end{matrix}$$

where

a₈ is a control constant and is a positive real number,

b₈ and c₈ are each a control constant,

d₈ is a control constant and is an odd number,

Cₛ(L,t) is a concentration of the radical scavenging ion on the cathode side,

C_{g}(L,t) is a concentration of the radical generating ion on the cathode side, and

Cₛ^{ave} is an average concentration of the radical scavenging ion.

### 2.6. Flow Chart

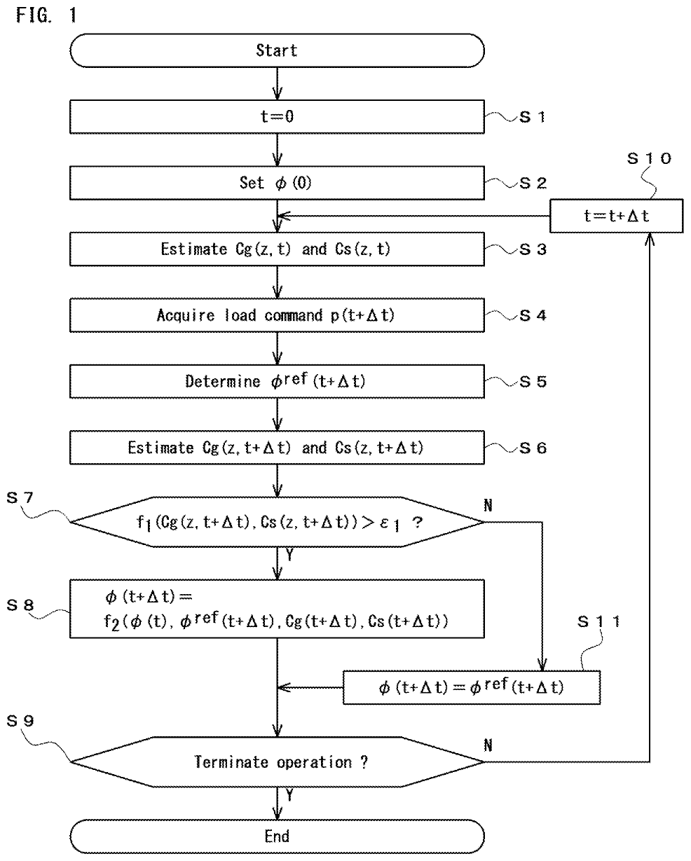

FIG. 1 shows a flow chart of the fuel cell control program according to the present invention. First, in Step 1 (hereinafter simply referred to as “S1”), substitute an initial value “0” for the time t.

Next, in S2, set an initial operation condition φ(0). A method of setting φ(0) is not particularly limited. For example, φ(0) can be set for such a condition as “flowing a minute amount of a supply gas after setting a humidity of the gas at 0% RH and an outlet pressure at atmospheric pressure while keeping a current at 0”.

Next, in S3, based on an operation condition φ(t) at the time t of a polymer electrolyte fuel cell containing a radical generating ion and a radical scavenging ion in the electrolyte thereof, estimate a concentration distribution C_{g}(z,t) of the radical generating ion and a concentration distribution Cₛ(z,t) of the radical scavenging ion in the electrolyte membrane (z is a position in the membrane thickness direction of the electrolyte membrane) and store them in a memory (Procedure A). A method of estimating the Cg(z,t) and Cs(z,t) has already been described above in detail so that a description on them is omitted.

Next, in S4, acquire a load command p(t+Δt) at a time(t+Δt) and stored it in the memory (Procedure B).

Next, in S5, acquire a reference operation condition φ^{ref}(t+Δt) under which the load command p(t+Δt) can be realized and store it in the memory (Procedure C).

Next, in S6, estimate a concentration distribution C_{g}(z,t+Δt) of the radical generating ion and a concentration distribution Cₛ(z,t+Δt) of the radical scavenging ion in the electrolyte membrane at the time (t+Δt) assuming that the φ^{ref}(t+Δt) is performed at the time (t+Δt) and store them in the memory (Procedure G). As described above, the Δt is relatively short so that S6 may be omitted.

Next, in S7, judge whether or not a judgment index f₁(C_{g}(z,t+Δt), Cₛ(z,t+Δt)) including C_{g}(z,t+Δt) and/or Cₛ(z,t+Δt) exceeds a first threshold value ϵ₁ (or is ϵ₁ or more) (Procedure D). When S6 is omitted, judge in S7 whether or not a judgment index f₁(C_{g}(z,t), Cₛ(z,t)) including C_{g}(z,t) and/or Cₛ(z,t) exceeds a first threshold value ϵ₁ (or is ϵ₁ or more).

When f₁>ϵ₁ (or f₁≥ϵ₁) holds (S7: YES), the electrolyte membrane may deteriorate if the φ^{ref}(t+Δt) is performed as is. In such a case, proceed to S8 and select an operation condition f₂ which is different from the φ^{ref}(t+Δt) and under which the f₁(C_{g}(z,t+Δt), Cₛ(z,t+Δt)) is El or less (or is less than ϵ₁) (Procedure E). The operation condition f₂ usually depends on the φ(t), φ^{ref}(t+Δt), C_{g}(z,t+Δt), and C_{g}(z,t+Δt).

Next, proceed to S9. In S9, judge whether or not the operation is terminated. When the operation is not terminated (S9: NO), proceed to S10. In S10, add At to the time t. Then, return to S3. Then, repeat the above-described steps S3 to S10 until the operation is terminated (S9: YES).

When f₁>ϵ₁ (or f₁≥ϵ₁) does not hold (S7: NO), the electrolyte membrane is not likely to deteriorate even if the φ^{ref}(t+Δt) is performed as is. In such a case, proceed to S11. In S11, select φ^{ref}(t+Δt) as φ(t+Δt) (Procedure E).

Next, proceed to S9. Then, repeat the above-described steps S3 to S11 until the operation is terminated (S9: YES).

### 3. Fuel Cell System

The fuel cell system according to the present invention includes:

a polymer electrolyte fuel cell,

a secondary battery for storing surplus electricity generated by the polymer electrolyte fuel cell, and

a control device for controlling an operation of the polymer electrolyte fuel cell and the secondary battery,

wherein the control device has a fuel cell control program according to the present invention housed therein.

### 3.1. Polymer Electrolyte Fuel Cell

In the present invention, the structure of the polymer electrolyte fuel cell is not particularly limited and the most suitable structure can be selected for it depending on the purpose.

### 3.2. Secondary Battery

A secondary battery is for storing surplus power generated using the polymer electrolyte fuel cell. In the present invention, as described above, in order to suppress deterioration of an electrolyte membrane, the polymer electrolyte fuel cell does not always generate power equivalent to the load command p. Therefore, the power generated using the polymer electrolyte fuel cell may have an excess or deficiency relative to the load command p. In the present invention, the secondary battery is used not only for simply storing surplus power but also for eliminating the excess or deficiency of power relative to the load command p.

### 3.3. Control Device

A control device is for controlling the operation conditions of the polymer electrolyte fuel cell and secondary battery. The fuel cell system usually has, in addition to a fuel cell,

(a) a fuel gas supply device for supplying a fuel (anode gas) to an anode,

(b) an oxidizing agent gas supply device for supplying an oxidizing agent (cathode gas) to a cathode,

(c) a humidifier for humidifying the anode gas and/or the cathode gas,

(d) a cooling device for cooling the fuel cell, and

(e) a condenser for separating a liquid from an anode-side and/or cathode-side discharged gas, and the like.

The control device is for controlling the operation of these devices.

In the present invention, the control device has the control program according to the present invention housed therein. The fuel cell system according to the present invention is different from the conventional one in the above-described point. The details of the fuel cell control program are as described above so that a description on them will be omitted.

### 4. Effect

Some metal ions (for example, Fe ion) are known to have an effect of forming a radical in a fuel cell. Intrusion of such an ion (radical generating ion) in an electrolyte membrane as an impurity may be a cause of the deterioration in the electrolyte membrane.

On the other hand, some metal ions (for example, Ce ion) are known to have an effect of scavenging a radical in the fuel cell. Addition of such an ion (radical scavenging ion) to the electrolyte membrane in advance may suppress the deterioration of the electrolyte membrane even if the radical generation ion intrudes in the electrolyte membrane.

The radical generating ion and the radical scavenging ion are both distributed uniformly in the electrolyte membrane when the fuel cell is stopped, but when the fuel cell is activated, they transfer to a cathode side or an anode side due to a potential gradient, ion concentration gradient, humidity gradient, or the like. In addition, the transfer rate of the radical generating ion is usually different from the transfer rate of the radical scavenging ion. During a phase of a current increase from a stopped state or a phase of a current decrease from a steady state, transfer of either one of them is delayed and there temporarily appears a region in which the concentration of the radical generating ion becomes relatively excessive compared with the concentration of the radical scavenging ion. As a result, in the region where the radical generation ion is concentrated, the electrolyte membrane may deteriorate.

The fuel cell control program according to the present invention, on the other hand,

(a) successively estimates a concentration distribution C_{g}(z,t) of a radical generating ion and a concentration distribution Cₛ(z,t) of a radical scavenging ion in an electrolyte membrane at a time t (Procedure A),

(b) judges whether or not a locally concentrated region of the radical generating ion is formed (in other words, judges whether or not the judgment index f₁(C_{g}(z,t), Cₛ(z,t)) exceeds a first threshold value ϵ₁) when an operation condition is changed (in other words, when a load demand p(t+Δt) at a time (t+Δt) is acquired) and the changed operation condition is performed as is (Procedures B to D), and

(c) selects an operation condition different from a reference operation condition φ^{ref}(t+Δt) which is to be determined based on the load command p(t+Δt) (in other words, selects an operation condition capable of mitigating the local concentration of the radical generating ion), when it is judged that there is a high possibility of a region in which the radical generating ion is locally concentrated being formed (Procedure E).

Even if there is a change in the potential gradient, ion concentration gradient, humidity gradient, or the like which may occur in the electrolyte membrane during the operation of the fuel cell, therefore, it is possible to suppress the deterioration of the electrolyte membrane caused by the temporary formation of a region in which the radical generating ion is concentrated.

### EXAMPLE

### Example 1, Comparative Example 1

### 1. Test Method

A simulation was performed to obtain a change in an ion concentration ratio (=concentration of the radical generating ion/concentration of the radical scavenging ion) at the time when a fuel cell containing, in an electrolyte membrane thereof, a predetermined amount of the radical generating ion and the radical scavenging ion was started. For the simulation, the model equation described in Reference Literature 2 was used.

The changes in ion concentration ratio were determined respectively:

in the case (a) where a fuel cell was controlled using the control program according to the present invention (Example 1), and

in the case (b) where a fuel cell was controlled so as to obtain an output as ordered by the load command (Comparative Example

In addition, the transfer rate of the radical generating ion (for example, Fe ion) was assumed to be faster than that of the radical scavenging ion (for example, Ce ion).

### 2. Result

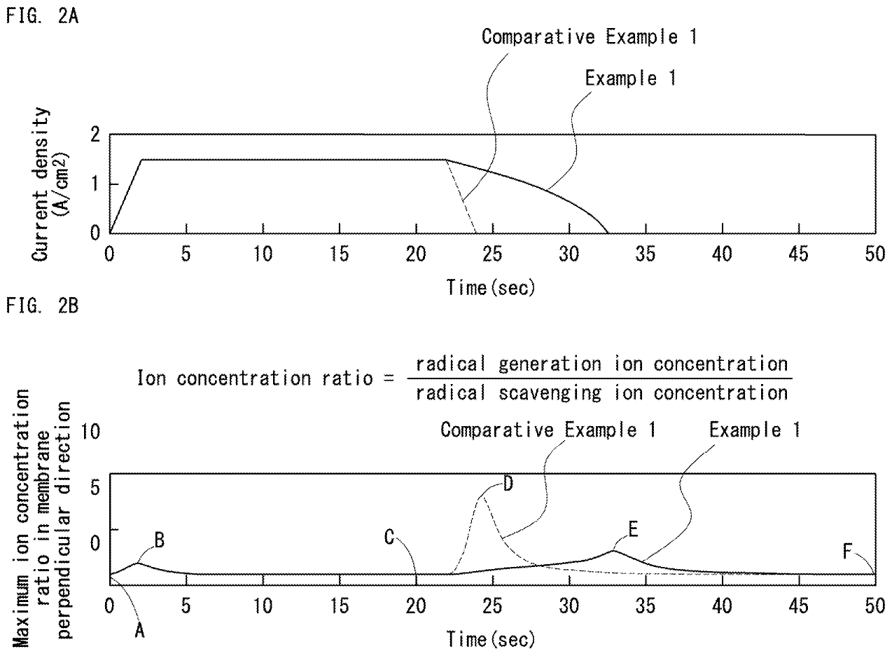

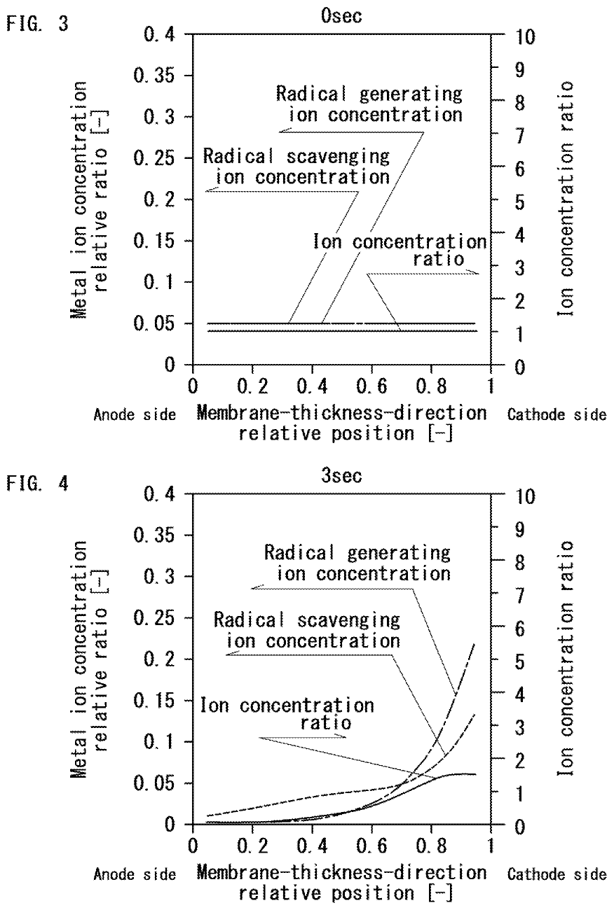

FIG. 2(A) shows a time-dependent change of a current density. FIG. 2(B) shows a time-dependent change of the maximum ion concentration ratio in the membrane perpendicular direction. FIGS. 3 to 8 respectively show the relation between a membrane-thickness-direction relative position and a metal ion concentration relative ratio or an ion concentration ratio at Points A to F in FIG. 2(B).

It is to be noted that the term “metal ion concentration relative ratio” means a ratio of anionic groups occupied by each metal ion among the anionic groups in the electrolyte membrane. Assuming that the concentration of the anionic group is Cₐₙᵢₒₙ, the valence number of the anionic group is Zₐₙᵢₒₙ, the concentration of the metal ion is C_{cation}, and the valence number of the metal ion is Z_{cation}, the following equation holds: metal ion concentration relative ratio=Z_{cation}·C_{cation}/(Zₐₙᵢₒₙ·Cₐₙᵢₒₙ).

The following can be understood from FIGS. 2 to 8.

(1) At the time t=0, the radical generating ion and the radical scavenging ion were distributed uniformly in the electrolyte membrane (FIG. 3). Increasing a current density from the aforesaid state increased the ion concentration ratio at point B in FIG. 2(B). This is because due to a fast transfer rate of the radical generating ion, there appears a region where the ion concentration ratio becomes large on the cathode side (FIG. 4).

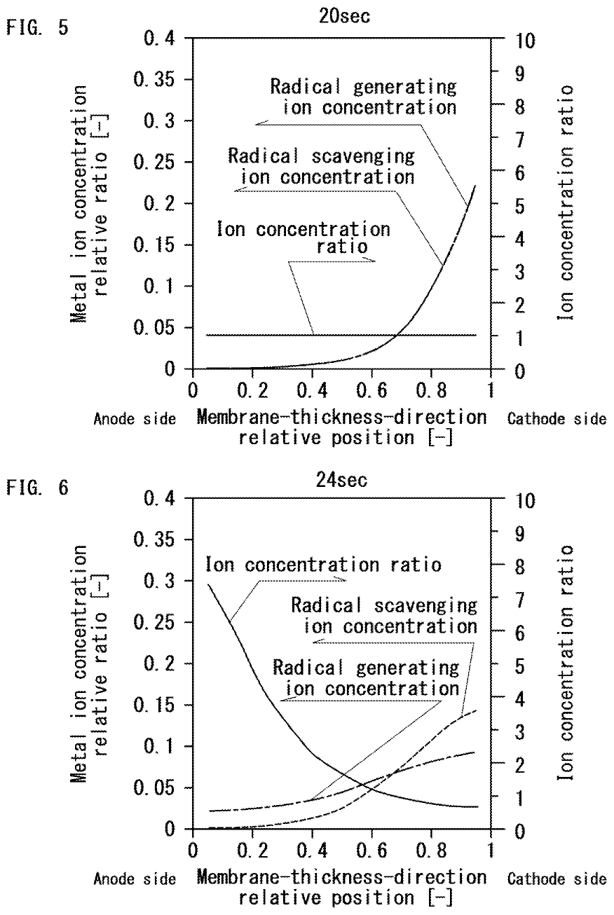

(2) After starting, when power generation was continued while keeping the current density constant, the ion concentration ratio showed a constant value. This is because a flux by a metal-ion concentration gradient and a flux by a potential gradient are balanced and the segregation of the metal ion reached a steady state (FIG. 5).

(3) About 22 seconds after starting, a current density was rapidly decreased. In that case, in Comparative Example 1, the ion concentration ratio at point D rapidly increased. As the current density was decreased rapidly, the metal ion tried to return to a uniform state. The time constant of the transport of the radical scavenging ion was larger than the time constant of the radical generating ion, which retarded the uniformization of the radical scavenging ion. As a result, it is presumed that a region where the ion concentration ratio showed a large increase appeared on the anode side (FIG. 6).

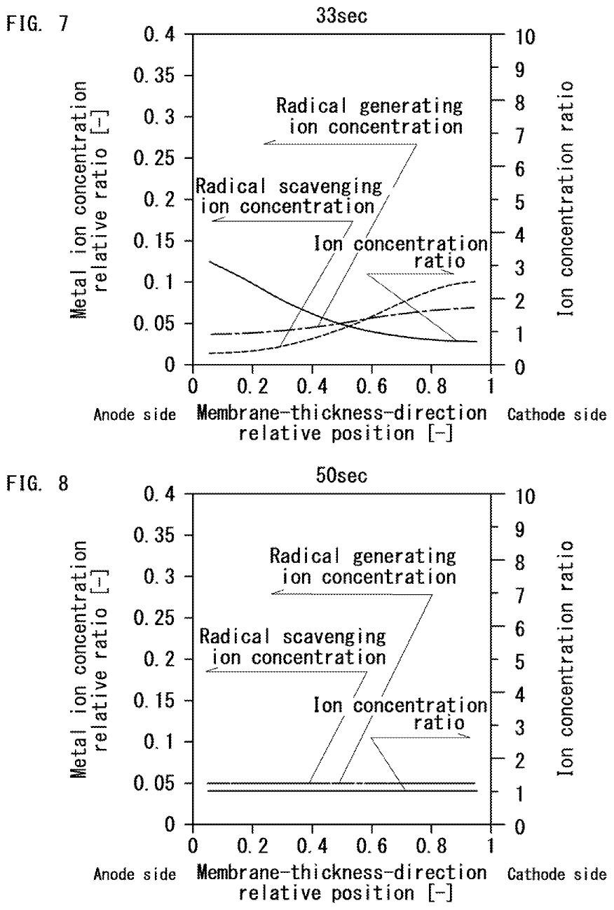

(4) On the other hand, in Example 1, an absolute value of a reduction rate of a current density was made smaller than that in Comparative Example 1. The ion concentration ratio therefore became maximum at Point E, but its magnitude was smaller by far than that at Point D (FIG. 7).

(5) When kept at a low current thereafter, the ion concentration ratio gradually decreased. At Point F, the metal ion concentration became uniform again (FIG. 8).

Thus, the embodiment of the present invention was described in detail. The present invention is however not limited by the aforesaid embodiment and can be modified in various ways without departing from the gist of the present invention.

### INDUSTRIAL APPLICABILITY

The fuel cell control program according to the present invention can be used for the control of the operation condition of a polymer electrolyte fuel cell to be used as a vehicle power source.

1. A fuel cell control program for having a computer perform the following procedures:
(A) Procedure A of estimating, based on an operation condition φ(t) at a time t of a polymer electrolyte fuel cell containing, in an electrolyte membrane thereof, a radical generating ion and a radical scavenging ion, a concentration distribution C_{g}(z,t) of the radical generating ion and a concentration distribution Cₛ(z,t) of the radical scavenging ion (wherein z means a membrane-thickness direction position in the electrolyte membrane) in the electrolyte membrane and storing the concentration distributions in a memory,
(B) Procedure B of acquiring a load command p(t+Δt) at a time (t+Δt) and storing the load command in the memory,
(C) Procedure C of acquiring a reference operation condition φ^{ref}(t+Δt) under which the load command p(t+Δt) can be realized and storing the reference operation condition in the memory,
(D) Procedure D of judging whether or not a judgment index f₁(C_{g}(z,t), Cₛ(z,t)) including the C_{g}(z,t) and/or the Cₛ(z,t) exceeds a first threshold value ϵ₁ (or is ϵ₁ or more), and
(E) Procedure E of selecting, as the φ(t+Δt), an operation condition which is different from the φ^{ref}(t+Δt) and under which the f₁(C_{g}(z,t), Cₛ(z,t)) is not more than the ϵ₁ (or is less than the ϵ₁) when the f₁(C_{g}(z,t), Cₛ(z,t)) is judged to exceed the ϵ₁ (or is judged to be the ϵ₁ or more) in the Procedure D and
selecting, as the φ(t+Δt), the φ^{ref}(t+Δt) when the f₁(C_{g}(z,t), Cₛ(z,t)) is judged not to exceed the ϵ₁ (or is judged not to be the ϵ₁ or more) in the Procedure D.

2. The fuel cell control program according to claim 1, wherein the f₁(C_{g}(z,t), Cₛ(z,t)) is represented by any of the following equations (1) to (3).
$$\begin{matrix}[ Math . 1 ] & \\ {f}_{1} ( {C}_{g} ( z , t ) , {C}_{s} ( z , t ) ) = max \{ \frac{{C}_{g} ( z , t )}{{C}_{s} ( z , t )} \} & ( 1 )\end{matrix}$$
$${f}_{1} ( {C}_{g} ( z , t ) , {C}_{s} ( z , t ) ) = max \{ {C}_{g} ( z , t ) \} \qquad ( 2 )$$
$${f}_{1} ( {C}_{g} ( z , t ) , {C}_{s} ( z , t ) ) = max \{ {C}_{s} ( z , t ) \} \qquad ( 3 )$$

3. The fuel cell control program according to claim 1, further comprising, after the Procedure C and before the Procedure D, Procedure G of estimating a concentration distribution C_{g}(z,t+Δt) of the radical generating ion and a concentration distribution C3(z,t+Δt) of the radial scavenging ion in the electrolyte membrane at the time (t+Δt) assuming that the φ^{ref}(t+Δt) is performed at the time (t+Δt) and storing the concentration distributions in the memory,
wherein the Procedure D includes a procedure of judging whether or not a judgment index f₁(C_{g}(z,t+Δt), Cₛ(z,t+Δt)) instead of the judgment index f₁(C_{g}(z,t), Cₛ(z,t)) exceeds the ϵ₁ (or is the ϵ₁ or more).

4. The fuel cell control program according to claim 1, wherein the Procedure E comprises:
(a) Procedure E₁₁ of setting a current I(t+Δt) at a time (t+Δt) to make an absolute value of a current reduction rate smaller than that in the case where the φ^{ref}(t+Δt) is assumed to be performed when a transfer rate of the radical scavenging ion is slower than a transfer rate of the radical generating ion,
(b) Procedure E₁₂ of setting the current I(t+Δt) at the time (t+Δt) to make an absolute value of a current increase rate smaller than that in the case where the φ^{ref}(t+Δt) is assumed to be performed when a transfer rate of the radical scavenging ion is faster than a transfer rate of the radical generating ion,
(c) Procedure E₂₁ of setting a voltage V(t+Δt) at the time (t+Δt) to make an absolute value of a voltage reduction rate smaller than that in the case where the φ^{ref}(t+Δt) is assumed to be performed when a transfer rate of the radical scavenging ion is slower than a transfer rate of the radical generating ion, and/or
(d) Procedure E₂₂ of setting the voltage V (t+Δt) at the time (t+Δt) to make an absolute value of a voltage increase rate smaller than that in the case where the φ^{ref}(t+Δt) is assumed to performed when a transfer rate of the radical scavenging ion is faster than a transfer rate of the radical generating ion.

5. The fuel cell control program according to claim 4, wherein the Procedures E₁₁ and E₁₂ each comprise a procedure of setting the I(t+Δt) by using the following equation (4):
$$\begin{matrix}[ Math . 2 ] & \\ I ( t + Δ t ) = I ( t ) + \frac{1}{{a}_{1}} max ( {a}_{1} ( \frac{{I}^{ref} ( t + Δ t ) - I ( t )}{Δ t} ) , {f}_{I} ( {C}_{s} ( z , t ) , {C}_{g} ( z , t ) ) ) Δ t & ( 4 )\end{matrix}$$
wherein,
f_{I}(Cₛ(z,t), C_{g}(z,t)) is a minimum absolute value of a current change rate determined depending on a concentration of the radical scavenging ion or a concentration of the radical generating ion on a cathode-side surface or anode-side surface of the electrolyte membrane,
I^{ref}(t+Δt) is a reference current included in the reference operation condition φ^{ref}(t+Δt), and
a₁ is a control constant which is a positive real number in the Procedure E₁₁ and is a negative real number in the Procedure E₁₂.

6. The fuel cell control program according to claim 4, wherein the Procedures E₂₁ and E₂₂ each comprise a procedure of setting the V(t+Δt) by using the following equation (5):
$$\begin{matrix}[ Math . 3 ] & \\ V ( t + Δ t ) = V ( t ) + \frac{1}{{2}_{1}} max ( {a}_{2} ( \frac{{V}^{ref} ( t + Δ t ) - V ( t )}{Δ t} ) , {f}_{V} ( {C}_{s} ( z , t ) , {C}_{g} ( z , t ) ) ) Δ t & ( 5 )\end{matrix}$$
wherein,
fᵥ(Cₛ(z,t), C_{g}(z,t)) is a minimum absolute value of a voltage change rate determined depending on a concentration of the radical scavenging ion or a concentration of the radical generating ion on a cathode-side surface or anode-side surface of the electrolyte membrane,
V^{ref}(t+Δt) is a reference voltage included in the reference operation condition φ^{ref}(t+Δt), and
a₂ is a control constant and is a negative real number in the Procedure E₂₁ and a positive real number in the Procedure E₂₂.

7. The fuel cell control program according to claim 1,
wherein the Procedure E comprises:
(a) Procedure E₃₁ of setting a relative humidity RH_{ca}(t+Δt) of a cathode gas at the time (t+Δt) to be higher than that under the φ^{ref}(t+Δt) when a concentration of the radical scavenging ion or radical generating ion on a cathode side is higher than that on an anode side,
(b) Procedure E₃₂ of setting the relative humidity RH_{ca}(t+Δt) of the cathode gas at the time (t+Δt) to be lower than that under the φ^{ref}(t+Δt) when a concentration of the radical scavenging ion or radical generating ion on the anode side is higher than that on the cathode side,
(c) Procedure E₄₁ of setting a relative humidity RHₐₙ(t+Δt) of an anode gas at the time (t+Δt) to be lower than that under the φ^{ref}(t+Δt) when the concentration of the radical scavenging ion or the radical generating ion on the cathode side is higher than that on the anode side, and/or
(d) Procedure E₄₂ of setting the relative humidity RHₐₙ(t+Δt) of the anode gas at the time (t+Δt) to be higher than that under the φ^{ref}(t+Δt) when the concentration of the radical scavenging ion or the radical generating ion on the anode side is higher than that on the cathode side.

8. The fuel cell control program according to claim 7, wherein the Procedures E₃₁ and E₃₂ each comprise a procedure of setting the RH_{ca}(t+Δt) by using the following equation (6):
[Math. 4]
RH_{ca}(t+Δt)=RH_{ca}^{ref}(t+Δt)+f_{RH}^{ca}(Cₛ(z,t), C_{g}(z,t)) (6)
wherein,
the f_{PH}^{ca}(Cₛ(z,t), C_{g}(z,t)) is a change margin of a cathode-side humidity determined depending on a concentration of the radical scavenging ion or a concentration of the radical generating ion on a cathode-side surface or anode-side surface of the electrolyte membrane, and
the RH_{ca}^{ref}(t+Δt) is a reference relative humidity of the cathode gas included in the reference operation condition φ^{ref}(t+Δt).

9. The fuel cell control program according to claim 7, wherein the Procedures E₄₁ and E₄₂ each comprise a procedure of setting the RHₐₙ(t+Δt) by using the following equation (7):
[Math. 5]
RHₐₙ(t+Δt)=RHₐₙ^{ref}(t+Δt)+f_{RH}^{an}(Cₛ(z,t), C_{g}(z,t)) (7)
wherein,
the f_{RH}^{an}(Cₛ(z,t), C_{g}(z,t)) is a change margin of an anode-side humidity determined depending on a concentration of the radical scavenging ion or a concentration of the radical generating ion on a cathode-side surface or anode-side surface of the electrolyte membrane, and
the RHₐₙ^{ref}(t+Δt) is a reference relative humidity of the anode gas contained in the reference operation condition φ^{ref}(t+Δt).

10. The fuel cell control program according to claim 1, wherein the Procedure E comprises:
(a) Procedure E₅₁ of setting a pressure P_{ca}(t+Δt) of a cathode gas at the time (t+Δt) to be higher than that under the φ^{ref}(t+Δt) when a concentration of the radical scavenging ion or the radical generating ion on a cathode side is higher than that on an anode side,
(b) Procedure E₅₂ of setting the pressure P_{ca}(t+Δt) of the cathode gas at the time (t+Δt) to be lower than that under the φ^{ref}(t+Δt) when a concentration of the radical scavenging ion or the radical generating ion on the anode side is higher than that on the cathode side,
(c) Procedure E₆₁ of setting a pressure Pₐₙ(t+Δt) of an anode gas at the time (t+Δt) to be lower than that under the φ^{ref}(t+Δt) when the concentration of the radical scavenging ion or the radical generating ion on the cathode side is higher than that on the anode side, and/or
(d) Procedure E₆₂ of setting the pressure Pₐₙ(t+Δt) of the anode gas at the time (t+Δt) to be higher than that under the φ^{ref}(t+Δt) when the concentration of the radical scavenging ion or the radical generating ion on the anode side is higher than that on the cathode side.

11. The fuel cell control program according to claim 10, wherein the Procedures E₅₁ and E₅₂ each comprise a procedure of setting the P_{ca}(t+Δt) by using the following equation (8):
[Math. 6]
P_{ca}(t+Δt)=P_{ca}^{ref}(t+Δt)+fₚ^{ca}(Cₛ(z,t), C_{g}(z,t)) (8)
wherein,
the fₚ^{ca}(Cₛ(z,t), C_{g}(z,t)) is a change margin of the pressure of the cathode gas determined depending on a concentration of the radical scavenging ion or a concentration of the radical generating ion on a cathode-side surface or anode-side surface of the electrolyte membrane, and
the P_{ca}^{ref}(t+Δt) is a reference pressure of the cathode gas included in the reference operation condition φ^{ref}(t+Δt).

12. The fuel cell control program according to claim 10, wherein the Procedures E₆₁ and E₆₂ each comprise a procedure of setting the Pₐₙ(t+Δt) by using the following equation (9):
[Math. 7]
Pₐₙ(t+Δt)=Pₐₙ^{ref}(t+Δt)+f_{P}^{an}(Cₛ(z,t), C_{g}(z,t)) (9)
wherein,
the fₚ^{an}(Cₛ(z,t), C_{g}(z,t)) is a change margin of the pressure of the anode gas determined depending on a concentration of the radical scavenging ion or a concentration of the radical generating ion on a cathode-side surface or anode-side surface of the electrolyte membrane, and
the Pₐₙ^{ref}(t+Δt) is a reference pressure of the anode gas included in the reference operation condition φ^{ref}(t+Δt).

13. The fuel cell control program according to claim 1,
wherein the Procedure E comprises:
(a) Procedure E₇₁ of setting a flow rate Q_{ca}(t+Δt) of a cathode gas at the time (t+Δt) to be smaller than that under the φ^{ref}(t+Δt) when a concentration of the radical scavenging ion or the radical generating ion on a cathode side is higher than that on an anode side,
(b) Procedure E₇₂ of setting the flow rate Q_{ca}(t+Δt) of the cathode gas at the time (t+Δt) to be larger than that under the φ^{ref}(t+Δt) when a concentration of the radical scavenging ion or the radical generating ion on the anode side is higher than that on the cathode side,
(c) Procedure E₈₁ of setting a flow rate Qₐₙ(t+Δt) of an anode gas at the time (t+Δt) to be larger than that under the φ^{ref}(t+Δt) when the concentration of the radical scavenging ion or the radical generating ion on the cathode side is higher than that on the anode side, and/or
(d) Procedure E₈₂ of setting the flow rate Qₐₙ(t+Δt) of the anode gas at the time (t+Δt) to be smaller than that under the φ^{ref}(t+Δt) when the concentration of the radical scavenging ion or the radical generating ion on the anode side is higher than that on the cathode side.

14. The fuel cell control program according to claim 13, wherein the Procedures E₇₁ and E₇₂ each comprise a procedure of setting the Q_{ca}(t+Δt) by using the following equation (10):
[Math. 8]
Q_{ca}(t+Δt)=Q_{ca}^{ref}(t+Δt)+f_{Q}^{ca}(Cₛ(z,t), C_{g}(z,t)) (10)
wherein,
the f_{Q}^{ca}(Cₛ(z,t), C_{g}(z,t)) is a change margin of the flow rate of the cathode gas determined depending on a concentration of the radical scavenging ion or a concentration of the radical generating ion on a cathode-side surface or anode-side surface of the electrolyte membrane, and
the Q_{ca}^{ref}(t+Δt) is a reference flow rate of the cathode gas included in the reference operation condition φ^{ref}(t+Δt).

15. The fuel cell control program according to claim 13, wherein the Procedures E₈₁ and E₈₂ each comprise a procedure of setting the Qₐₙ(t+Δt) by using the following equation (11):
[Math. 9]
Qₐₙ(t+Δt)=Qₐₙ^{ref}(t+Δt)+f_{Q}^{an}(Cₛ(z,t), C_{g}(z,t)) (11)
wherein,
the f_{Q}^{an}(Cₛ(z,t), C_{g}(z,t)) is a change margin of the flow rate of the anode gas determined depending on a concentration of the radical scavenging ion or a concentration of the radical generating ion on a cathode-side surface or anode-side surface of the electrolyte membrane, and
Qₐₙ^{ref}(t+Δt) is a reference flow rate of the anode gas included in the reference operation condition φ^{ref}(t+Δt).

16. The fuel cell control program according to claim 1, wherein the Procedure A comprises:
(a) a procedure of estimating the C_{g}(z,t) and the Cₛ(z,t) by using a metal ion transport equation, or
(b) a procedure of estimating the C_{g}(z,t) and the Cₛ(z,t) by using a first map showing a relation between a reference operation condition φ^{ref}(t) at the time t and a concentration C_{g}^{ref}(z,t) of the radical generation ion and a concentration Cₛ^{ref}(z,t) of the radical scavenging ion under a steady state (dC/dt=0) of the φ^{ref}(t) and a second map showing a relation between the reference operation condition φ^{ref}(t) and a time constant τ of metal ion transport.

17. A fuel cell system, comprising:
a polymer electrolyte fuel cell,
a secondary battery for storing a surplus power generated by the polymer electrolyte fuel cell, and
a control device for controlling operation of the polymer electrolyte fuel cell and the secondary battery,
wherein the control device has, housed therein, the fuel cell control program as claimed in claim 1.
